(19) United States
(12) Patent Application Publication
(10) Pub. No.: US 2026/0358258 A1
(43) Pub. Date: Nov. 12, 2026

(54) OZONE GENERATOR FOR A CHEMILUMINESCENCE ANALYZER

(71) Applicant: AVL ANALYTICAL TECHNOLOGIES GMBH, NEUSS (DE)

(72) Inventor: NORBERT KREFT, NEUSS (DE)

(73) Assignee: AVL ANALYTICAL TECHNOLOGIES GMBH, NEUSS (DE)

(21) Appl. No.: 19/666,376

(22) Filed: May 4, 2026

(30) Foreign Application Priority Data
May 7, 2025 (DE) 10 2025 117 470.9

(51) Int. Cl. G01N 21/76; B01J 19/08; C01B 13/11

(52) U.S. Cl. CPC G01N 21/766; B01J 19/088; C01B 13/115; B01J 2219/0809; C01B 2201/22

(57) ABSTRACT

An ozone generator for a chemiluminescence analyzer. The ozone generator includes at least two plates, a channel which is formed between the plates, and electrodes. A flow can pass through the channel from an inlet to an outlet along a length thereof. A width of the channel is delimited by lateral wall surfaces. The electrodes comprise a first and a second electrode. The first electrode is arranged on a first side of the channel of the plates, and the second electrode is arranged on a second side of the channel of the plates. The first side is opposite to the second side. The electrodes are arranged outside of the channel and coextensive with the channel. When the electrodes are projected in a direction of a normal vector to the plates, the electrodes have a distance on both sides from the lateral wall surfaces laterally limiting the channel.

### CROSS REFERENCE TO PRIOR APPLICATIONS

Priority is claimed to German Patent Application No. DE 10 2025 117 470.9, filed May 7, 2025. The entire disclosure of said application is incorporated by reference herein.

### FIELD

The present invention relates to an ozone generator for a chemiluminescence analyzer, the ozone generator comprising at least two plates, a channel which is formed between the plates through which a flow can pass from an inlet to an outlet along its length and which is limited in width by lateral wall surfaces, and electrodes which are arranged on two opposite sides of the channel at the plates.

### BACKGROUND

Such plate ozone generators typically operate with an alternating voltage applied between two electrodes, thereby generating an electric field. A dielectric material is located between the electrodes. The channel formed between the plates, through which oxygen or air flows, is ionized by the electric field, whereby oxygen molecules are split by the discharges to form oxygen radicals. These oxygen radicals subsequently recombine to form ozone.

The ozone thereby generated is carried by an air stream to the chemiluminescence analyzer. It is there primarily used for nitrogen oxide analysis, however, the ozone can also be used, for example, for the analysis of sulfur monoxide or carbon monoxide. The ozone is mixed with nitrogen monoxide in the air stream and reacts to form excited NO₂, which emits light whose intensity can be measured by the detector to determine quantities.

These plate ozone generators typically consist of two or more plates stacked on top of one another to form a space therebetween for the conversion of oxygen, wherein air or oxygen is supplied through an inlet which exits a channel via an outlet after the ozone has been generated. The plates are made of a dielectric material. The necessary electric field is generated via electrodes that define the space or are formed outside the space.

US 2004/0136885 A1 describes an ozone generator comprising two dielectric plates that have semi-circular recesses in cross-section facing each other so that circular channels are formed by stacking the two plates. The electrodes used are rod-shaped, with one electrode arranged on the first plate within the groove and a second electrode formed on the outer side of the other plate. The parallel formed channels are connected to one another via end plates in which corresponding recesses are formed.

It was determined that when using air for ozone generation with this plate ozone generator, as with other known ozone generators, sufficiently stable ozone production cannot be ensured to determine nitrogen oxide amounts with sufficient accuracy when nitrogen oxide concentrations in the air stream are low. It is additionally not ensured that nitrogen oxides are formed in a manner that is sufficiently stable over time for analysis.

### SUMMARY

An aspect of the present invention is to provide an ozone generator with which low detection limits can be achieved on the chemiluminescence analyzer even when generating ozone from ambient air by providing a stable ozone and nitrogen oxide generation.

In an embodiment, the present invention provides an ozone generator for a chemiluminescence analyzer. The ozone generator includes at least two plates, a channel which is formed between the plates, and electrodes. A flow can pass through the channel from an inlet to an outlet along a length thereof. A width of the channel is delimited by lateral wall surfaces. The electrodes comprise a first and a second electrode. The first electrode is arranged on a first side of the channel of the plates, and the second electrode is arranged on a second side of the channel of the plates. The first side is opposite to the second side. The electrodes are arranged outside of the channel and coextensive with the channel. When the electrodes are projected in a direction of a normal vector to the plates, the electrodes have a distance on both sides from the lateral wall surfaces laterally limiting the channel.

### BRIEF DESCRIPTION OF THE DRAWINGS

The present invention is described in greater detail below on the basis of embodiments and of the drawings in which:

FIG. 1 shows a top view of the ozone generator where an internal channel is depicted by dashed lines; and

FIG. 2 shows a side view of the ozone generator from FIG. 1 in a cross-sectional view.

### DETAILED DESCRIPTION

The ozone generator of the present invention for a chemiluminescence analyzer comprises at least two plates between which a channel is formed, through which in particular air flows, the oxygen in which is to be partially converted into ozone. The air flows from an inlet to an outlet along the length of the channel. The width of the channel is limited by lateral wall surfaces, wherein the width extends perpendicular to the flow direction or length of the channel and parallel to the main plane of extension of the plates, while the height of the channel refers to the direction perpendicular to both the width and the length. The ozone generator also comprises electrodes arranged on the plates on two opposite sides of the channel to generate an electric field and ionize the channel accordingly so that the oxygen molecules are converted into charged ions and free electrons. The present invention provides that the electrodes are arranged outside of the channel and extend corresponding to the channel, i.e., the electrodes follow the direction of the channel’s extension. When the electrodes are projected in the direction of a normal vector to the plates, the electrodes on both sides maintain a distance from the wall surfaces laterally limiting the channel. The electrodes accordingly have a smaller width than the channel and end before the outlet and begin behind the inlet. The electric field is therefore not effective at the boundary layer between the flow and the flow-conducting material, i.e., at the lateral wall surfaces, thereby preventing the formation of inhomogeneities at the wall surfaces resulting from the differing electrical properties of the gas and the flow-conducting material since zones with high and inhomogeneous fields in the gas flow are avoided which might otherwise arise at the contours and at the inlet and outlet of the process gas. In such inhomogeneous fields, nitrogen oxides are produced in increased quantities in zones with high field strengths, which would cause the measured values to become inconsistent and no longer reproducible. The special arrangement accordingly makes it possible to provide for a stable ozone and nitrogen oxide generation, thereby achieving significantly lower detection limits and more accurate measured values. The risk of local electrical breakdowns is also reduced by avoiding these inhomogeneities, which would shorten the service life of the ozone generator.

The channel and the electrodes can, for example, extend in a meandering pattern. Meandering means that the channel changes direction between the plates, 180° bends are in particular formed at the plate ends, from where the channel extends straight toward the opposite plate end until the next 180° bend. This shape provides a uniform guided flow with a correspondingly uniform residence time of the air or oxygen in the channel within a confined space, thereby increasing the stability of ozone generation.

The ozone generator can, for example, comprise a first plate and a third plate, between which a second plate is arranged, the second plate having a through-opening forming the channel and which forms the wall surfaces delimiting the channel in its width, wherein the first plate delimits the channel on a side facing away from the third plate and the third plate delimits the channel on the side of the second middle plate facing away from the first plate. This simplifies manufacturing and in particular the production of very flat channel structures.

In a further embodiment of the present invention, a first opening can, for example, be formed in the first plate to serve as the inlet, and a second opening can, for example, be formed in the first plate to serve as the outlet. Simple axial bores through the first plate are sufficient therefor, thereby simplifying manufacturing and assembly.

The electrodes can, for example, be formed on outward-facing surfaces of the first and third plates. This simplifies the formation of the electrodes and enables the formation of very uniform electric fields inside the channel.

In an alternative embodiment of the present invention, the ozone generator can, for example, comprise two plates arranged one above the other, wherein both plates have corresponding grooves that form the channel, and the electrodes are formed on the surfaces of the plates facing away from the grooves. This configuration provides that one plate can be omitted, thereby also reducing the number of seals that may be necessary.

It is furthermore advantageous for the channel to have a substantially rectangular cross-section, wherein the width of the channel is at least five times the height of the channel. Due to the narrow gap, the electric field strength is higher at the same voltage, thereby increasing the efficiency of the corona discharge and thus generating more ozone. This also improves heat dissipation, which may be necessary due to the exothermic reaction. A uniform air flow with good mixing is also achieved, making ozone production more effective and stable.

In an embodiment of the present invention, the width of the electrodes can, for example, be 80 % to 95 % of the width of the channel. Boundary layers within the electric field, which lead to increased nitrogen oxide production and flow inhomogeneities within the electric field, are avoided in this range, thereby achieving a particularly stable ozone production.

In an embodiment of the present invention, the electrodes can, for example, be designed as thin-film electrodes. These enable the generation of a very homogeneous field in the channel with a high electric field strength, which leads to an improvement in the corona discharge and thus to increased efficiency, since energy consumption is also low. Another advantage is the relatively low heat capacity.

In an embodiment of the present invention, the thin-film electrodes can, for example, be formed as films, sputtered layers, or lacquer layers, or are produced by chemical vapor deposition. These deposition methods enable a high-precision fabrication of the electrodes.

The electrodes can, for example, have a length shorter than that of the channel and a distance from the inlet and outlet that is less than the width of the channel and greater than the distance to the lateral boundary walls of the channel. This provides uniformity of the flow after it enters the channel and before it exits the channel so that turbulence does not lead to instability during ozone generation. A distance from the walls delimiting the end and the beginning of the channel is also provided, whereby no inhomogeneities arise at these wall surfaces due to the different electrical properties of the gas and the flow-conducting material since zones with high and inhomogeneous fields in the gas flow are avoided.

The plates can, for example, be made of aluminum oxide. Aluminum oxide has high dielectric strength which allows for strong electric fields and reduces breakdowns. Aluminum oxide also has good thermal conductivity so that the resulting thermal energy can be dissipated more effectively. Aluminum oxide is also ozone- and corrosion-resistant, which increases the service life of the ozone generator. These plates can also be manufactured with high precision and with very smooth surfaces, thereby resulting in the formation of less intense boundary layers and eliminating the need for seals between the plates.

In an embodiment of the present invention, the plates can, for example, comprise corresponding through-holes outside the channel through which screws protrude, via which the plates are screwed together. This allows the creation of a sealed channel. It also provides for a very simply assembly.

This results in an ozone generator for a chemiluminescence analyzer that exhibits very high stability in ozone and nitrogen oxide production, thereby enabling very low detection limits for the chemiluminescence analyzer and providing highly accurate measurement values. Air can thereby be used as a gas to generate ozone. The ozone generator is also simple and inexpensive to manufacture and to assemble and has a long service life.

A non-limiting embodiment of an ozone generator according to the present invention is shown in the drawings and is explained in greater detail below.

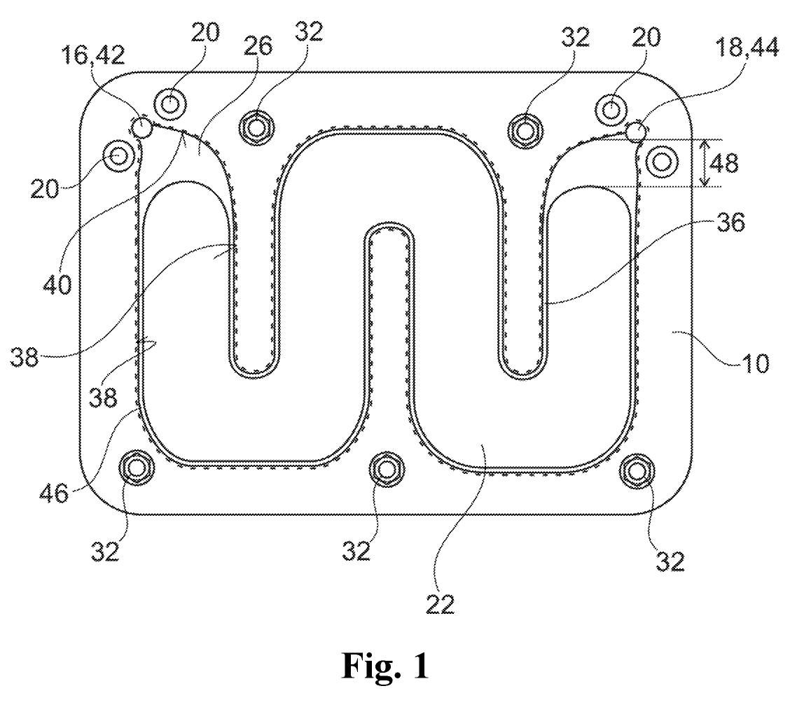

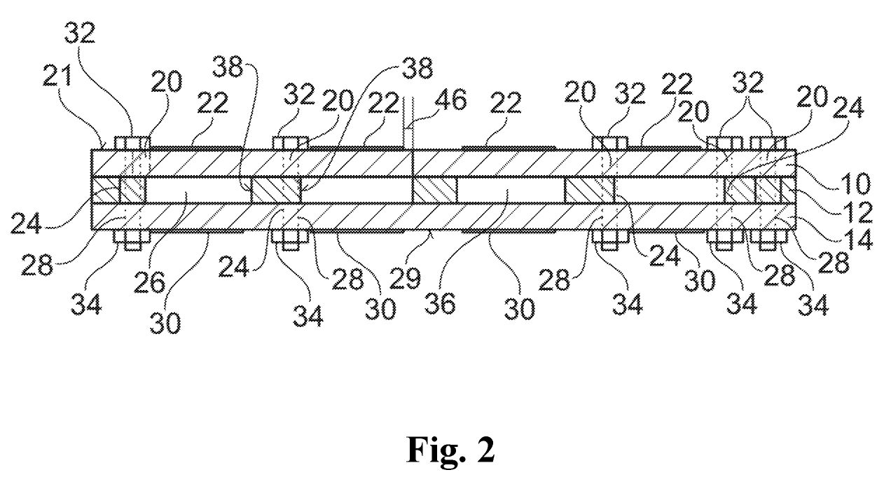

The ozone generator according to the present invention, as shown in FIGS. 1 and 2, consists of a total of three plates 10, 12, 14. The first plate 10 is designed as a rectangular flat plate in which a first opening 16 and a second opening 18 are formed. The first plate 10 also has several through-holes 20. On a side of the first plate 10 facing away from the second plate 12, a first electrode 22 is formed on a surface 21 of the first plate 10, which first electrode 22 is designed as a thin-film electrode and is produced by a foil, a sputtered layer, a lacquer layer, or by chemical vapor deposition, and is firmly bonded to the first plate 10.

The second, middle plate 12 is also designed as a flat rectangular plate and has the same dimensions as the first plate 10. This second plate 12 also has through-holes 24 corresponding to the through-holes 20 of the first plate 10 so that the through-holes 20 are extended by the through-holes 24 when the two plates 10, 12 are stacked on top of one another. Internally, the second plate 12 comprises a through-opening 26 that extends in a meandering pattern along the length and width of the second plate 12. This through-opening 26 initially runs parallel to one side of the second plate 12 until, before reaching the end of the second plate 12, it bends by 180° and extends to the opposite side, where it again bends 180° and continues to extend parallel to the first and second sections. Depending on the plate size, any number of bends and straight sections can thus be formed.

The third plate 14 is essentially formed as a closed plate, except that corresponding through-holes 28 are also formed in this third plate 14, through which the through-holes 20, 24 of the first and second plates 10, 12 are extended. The third plate 14 also has the same dimensions as the first and second plates 10, 12. A second electrode 30 is formed using thin-film technology on a surface 29 of the third plate 14 facing away from the second plate 12.

The three plates 10, 12, 14, which are, for example, made of aluminum oxide, are connected to one another via screws 32, which are inserted through the through-holes 20, 24, 28, and nuts 34. This forms a channel 36, the height of which is limited by the first and third plates 10, 14, the width of which is limited by lateral wall surfaces 38 facing the through-opening 26, and the length of which is limited by lateral wall surfaces 40 of the second plate 12 arranged at the beginning and end of the formed channel 36. The channel 36 is flat and has a height-to-width ratio of approximately 1:10. The first opening 16 opens into the channel 36 in the area of one of the two wall surfaces 40 delimiting the channel 36 in its length and forms an inlet 42 of the ozone generator. The second opening 18 opens into channel 36 in the region of the other wall surfaces 40 delimiting channel 36 along its length and forms an outlet 44 of the ozone generator.

The electrodes 22, 30 have a shape corresponding to the shape of the channel 36, thus extending in a meandering pattern along channel 36 on the surfaces 21, 29 of the first and third plates 10, 14. However, with respect to a projection in the direction of a normal vector to the outward-facing surfaces 21, 29 of the first and third plates 10, 14, the electrodes 22, 30 maintain a distance 46 from the wall surfaces 38 laterally limiting the channel 36. This distance 46 corresponds to approximately 5 % of the width of the channel 36 on both sides, so that the width of the electrodes corresponds to approximately 90 % of the width of the channel 36. The lateral distance of the electrodes 22, 30 from the side-limiting wall surfaces 38 is equal on both sides relative to the width of the channel 36. The electrodes 22, 30 also maintain a distance 48 from the wall surfaces 40 that delimit the channel 36 along its length, as well as from the inlet 42 and the outlet 44. This distance is approximately 50 % of the width of the channel 36, allowing for initial flow stabilization.

When an air stream is drawn into channel 36 through inlet 42 and a high-frequency voltage is applied to electrodes 22 and 30, a strong electric field is generated, causing the electrons to accelerate and collide with oxygen molecules. The molecules are split and ionized in this process. Since the resulting free oxygen atoms are highly reactive, they react with existing oxygen molecules to form ozone, so that the air stream exiting channel 36 contains ozone molecules, which is necessary for the detection of nitrogen oxides in a chemiluminescence analyzer. Since the amount of ozone supplied to the analyzer influences its measurement results, it is necessary for the supplied ozone flow to be as stable as possible in order to achieve low detection limits and high accuracy. The described alignment of the electrodes 22, 30 with channel 36 prevents the formation of zones with inhomogeneous electric fields, which could arise primarily in the boundary layers of a flow and thus at the wall surfaces 38, 40 of channel 36 due to the differing electrical properties of the flow and the limiting material. Due to the distance between the electrodes 22, 30 and these wall surfaces 38, 40, the electric field is not effective in this area so that no ionization there occurs. The air flow is thus always guided along the homogeneous electric field or outside the electric field, thereby reducing the risk of electrical breakdowns and providing both uniform ozone formation and uniform formation of nitrogen oxides.

It should be clear that the ozone generator can, for example, also be manufactured with only two plates, in which grooves facing each other are formed on the inside and which have electrodes on the outside corresponding to the first and third plates of the described embodiment. The shape of the channel and the electrodes, as well as the materials and dimensions, can also be adapted compared to the embodiment.

The present invention is not limited to embodiments described herein; reference should be had to the appended claims.

### LIST OF REFERENCE NUMERALS

10 First plate
12 Second plate
14 Third plate
16 First opening
18 Second opening
20 Through-holes (of first plate 10)
21 Surface (of first plate 10)
22 First electrode
24 Through-holes (of second plate 12)
26 Through-opening (of second plate 12)
28 Through-holes (of third plate 14)
29 Surface (of third plate 14)
30 Second electrode
32 Screw
34 Nut
36 Channel
38 Wall surface 40 Wall surface (of second plate 12)
42 Inlet
44 Outlet
46 Distance
48 Distance

What is claimed is:

1. An ozone generator for a chemiluminescence analyzer, the ozone generator comprising:
at least two plates;
a channel which is formed between the at least two plates, the channel being configured so that a flow can pass therethrough from an inlet to an outlet along a length of the channel, a width of the channel being delimited by lateral wall surfaces; and
electrodes comprising a first electrode and a second electrode, the first electrode being arranged on a first side of the channel of the at least two plates, and the second electrode being arranged on a second side of the channel of the at least two plates, the first side being opposite to the second side,
wherein,
the electrodes are arranged outside of the channel and coextensive with the channel, and
when the electrodes are projected in a direction of a normal vector to the at least two plates, the electrodes have a distance on both sides from the lateral wall surfaces laterally limiting the channel.

2. The ozone generator as recited in claim 1, wherein the channel and the electrodes each extend in a meandering pattern.

3. The ozone generator as recited in claim 1, wherein,
the at least two plates comprise a first plate, a second plate and a third plate,
the second plate is arranged between the first plate and the third plate,
the second plate comprises a through-opening which forms the channel and the lateral wall surfaces delimiting the width of the channel,
the first plate delimits the channel on a first side of the second plate facing away from the third plate, and
the third plate delimits the channel on a second side of the second plate facing away from the first plate.

4. The ozone generator as recited in claim 3, wherein,
the first plate comprises a first opening and a second opening,
the first opening forms the inlet, and
the second opening forms the outlet.

5. The ozone generator as recited in claim 4, wherein,
the first plate further comprises an outward-facing surface,
the third plate comprises an outward-facing surface,
the first electrode is arranged on the outward-facing surface of the first plate, and
the second electrode is arranged on the outward-facing surface of the third plate.

6. The ozone generator as recited in claim 5, wherein,
the first electrode and the second electrode each have a length which is shorter than the length of the channel, and
with respect to a projection onto the outward-facing surface of the first plate and of the outward-facing surface of the third plate, the first electrode and the second electrode each have a distance from the inlet and from the outlet that is smaller than the width of the channel and which is larger than the distance on both sides from the lateral wall surfaces laterally limiting the channel.

7. The ozone generator as recited in claim 1, wherein,
the at least two plates comprises a first plate and a second plate,
the first plate and the second plate are arranged one above the other,
each of the first plate and the second plate comprise corresponding grooves that form the channel, and
the first electrode is arranged on a surface of the first plate which faces away from the grooves, and
the second electrode is arranged on a surface of the second plate which faces away from the grooves.

8. The ozone generator as recited in claim 7, wherein,
the first electrode and the second electrode each have a length which is shorter than the length of the channel, and
with respect to a projection onto the surface of the first plate and of the surface of the second plate, the first electrode and the second electrode each have a distance from the inlet and from the outlet that is smaller than the width of the channel and which is larger than the distance on both sides from the lateral wall surfaces laterally limiting the channel.

9. The ozone generator as recited in claim 1, wherein,
a cross-section of the channel is substantially rectangular, and
the width of the channel is at least five times a height of the channel.

10. The ozone generator as recited in claim 1, wherein the electrodes have a width which is 80 % to 95 % of the width of the channel.

11. The ozone generator as recited in claim 1, wherein the electrodes are designed as thin-film electrodes.

12. The ozone generator as recited in claim 11, wherein the thin-film electrodes are formed as a foil, as sputtered layers, or as lacquer layers, or are produced by chemical vapor deposition.

13. The ozone generator as recited in claim 1, wherein the at least two plates are made of aluminum oxide.

14. The ozone generator as recited in claim 1, wherein the at least two plates each comprise corresponding through-holes which are arranged outside of the channel, the through-holes being configured so that screws can pass therethrough via which the plates are screwed together.
